(19) United States
(12) Patent Application Publication
(10) Pub. No.: US 2005/0135336 A1
(43) Pub. Date: Jun. 23, 2005

(54) Internet access system, method of data transmission in the internet access system and information terminal using the internet access system

(75) Inventors: Yuichi Kato, Tokyo (JP); Michihiro Enokida, Kawagoe-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: CITIZEN WATCH CO., LTD.

(21) Appl. No.: 10/817,795

(22) Filed: Apr. 6, 2004

(30) Foreign Application Priority Data
Apr. 8, 2003 (JP) 2003-104432

(51) Int. Cl. H04L 12/66; G06F 15/16

(52) U.S. Cl. 370/352; 709/249; 709/227

(57) ABSTRACT

The present invention is aimed to provide an Internet access system, a data transmission method in the Internet access system and an information terminal using the Internet access system. In the Internet access system, the data transmission method in the Internet access system and the information terminal using the Internet access system according to the present invention, a unique data to authenticate a transmission capability of a portable information device (10) is preliminary stored not to be rewritten in the portable information device, so that the unique data can be send to the Internet access system (50) when accessing the Internet. Accordingly, in the Internet access system, it is possible to be aware of the transmission capability of the portable information device requesting Internet access.

### FIELD OF THE INVENTION

The present invention relates to an Internet access system to bilaterally connect a circuit switching network provided by a primary common carrier and the Internet network, a data transmission method in such system and an information terminal using the Internet access system.

### BACKGROUND OF THE INVENTION

A user can perform data transmission by connecting a communication card such as for PHS (Personal Handyphone System) run by a common carrier to a portable information device such as a PDA (personal Digital Assistant) and a personal computer (PC). In such data transmission, the common carrier identifies a user using a unique number of the communication card, a predetermined user ID (Identification Number) and a password.

Recently, in data transmission, flat-rate system, which is independent of a connection time with the WWW server nor a connection time for the common carrier, has become very popular, because a user who has paid a preliminary-fixed fee can have a sense of security that he/she can access a server as much as he/she likes. For example, flat-rate fee is 5,000 yen per a month for a service of transmission speed 32 kbps, likewise, 8,000 yen for 64 kbps, 10,000 yen for 128 kbps and the like. In such flat-rate system, the user can download a large volume of data over a long time.

The user purchases a communication card of a desired transmission speed and contracts with a common carrier. However, the user may not actually perform appropriate data transmission at a maximum transmission speed bandwidth of the card depending on an average throughput of the portable information device the user uses.

Although the common carrier applies a rate system according to the maximum transmission speed bandwidth of the card used because the common carrier cannot confirm the average throughput of user's portable information device. Consequently, the user may overpay in spite of the fact that the maximum transmission speed bandwidth is not available to the user.

### SUMMARY OF THE INVENTION

In this connection, it is an object of the present invention to provide Internet access system, a data transmission system in the Internet access system and an information terminal using the Internet access system in which the above problems are solved.

It is another object of the present invention to provide an Internet access system, a data transmission system in the Internet access system and an information terminal using the Internet access system which can determine an transmission capability of a portable information device.

It is still another object of the present invention to provide Internet access system, a data transmission system in the Internet access system and an information terminal using the Internet access system which restrict an available transmission bandwidth according to the available throughput of the information terminal instead that the charge is settled low.

The Internet access system according to the present invention comprises a communication connection connector for establishing a communication connection to a predetermined point on the Internet in response to an Internet connection request from an information terminal, a receiver for receiving a unique data to authenticate the information terminal from a circuit switching network, and a determination section for determining a transmission capability of the information terminal based on the unique data. It is structured to be able to determine the transmission capability of the information terminal on establishing a communication connection with a predetermined point on the Internet (such as a WWW server or a mail server).

Preferably, in the Internet access system, the communication connector establishes the communication connection between the information terminal and a predetermined point on the Internet network corresponding to the connection request when the transmission capability satisfies a predetermined criteria.

Further preferably, in the Internet access system, the transmission capability is an average throughput.

More preferably, in the Internet access system, a communication card is connected to an information terminal, and the Internet access system receives a unique data, a user ID and a password of the information device via the communication card and circuit switching network.

Preferably, in the Internet access system, the information device is a portable information device.

Further preferably, in the Internet access system, an authentication section authenticates the user using the information terminal based on the user ID and the password, and the communication connector establishes the communication connection between the information terminal and the predetermined point on the Internet network corresponding to the connection request when the transmission capability satisfies the predetermined criteria and the user authentication is certified.

More preferably, in the Internet access system, the authentication section uses a data synthesized the user ID and the password for authentication.

The data transmission method according to the present invention comprises the steps of receiving a unique data for authenticating an information terminal from a circuit switching network, determining a transmission capability of the information terminal based on the unique data, and establishing a communication connection between the information terminal and a predetermined point on the Internet network corresponding to a connection request from the information terminal. It is structured that the communication connection between the information terminal and a server on the Internet network is established only after the transmission capability of the information terminal is determined.

Preferably, in the data transmission method, the communication establishing step establishes the communication connection between the information terminal and a predetermined point on the Internet network when the transmission capacity satisfies a predetermined criteria.

Further preferably, in the data transmission method, the transmission capability is an average throughput.

More preferably, in the data transmission method, a communication card is connected to the information terminal, and the Internet access system receives the unique data and a user ID and a password of the information device via the communication card and circuit switching network.

Preferably, in the data transmission method, the information device is a portable information device.

Further preferably, the data transmission method comprises the step of conducting an authentication of the user using the information terminal based on the user ID and the password, and the communication establishing step establishes the communication connection between the information terminal and the predetermined point on the Internet network when the transmission capability satisfies the predetermined criteria and the user authentication is certified.

More preferably, in the data transmission method, the authentication step uses a synthesized user ID and password for authentication.

The data transmission method according to the present invention comprises the steps of receiving unique data for authenticating the information terminal and a user ID and a password for using a portable information device from the circuit switching network, determining a average throughput based on the unique data, conducting an authentication of a user who use the portable information device based on the user ID and the password, and establishing a communication connection between the portable information device and a predetermined point on the Internet network at a predetermined connection rank when the average throughput satisfies a predetermined criteria and the user authentication is certified.

Preferably, in the data transmission method, the communication connection between the portable information device and a predetermined point on the Internet network is refused when the average throughput does not satisfy a predetermined criteria or a user authentication is not certified.

Further preferably, in the data transmission method, the communication connection between the portable information device and a predetermined point on the Internet network is established at a connection rank other than the predetermined connection rank according to the average throughput when the average throughput does not satisfy a predetermined criteria but the user authentication is certified.

The information terminal according to the present invention comprises a connector for connecting a communication card, a first memory for storing a unique data to authenticate a transmission capability of the information terminal, a second memory for storing a user ID and a password to use the Internet access system and a processor for taking the unique data, the user ID and the password from the first and second memory so as to send the unique data, the user ID and the password to the Internet access system by using the communication card for an access to the Internet access system. The information terminal is structured to be available in the Internet access system which can determine the transmission capability of the information terminal.

Preferably, in the information terminal, the unique data represents at least a transmission capability of the information terminal.

Further preferably, in the information terminal, the communication card has a unique data and the processor takes unique data of the communication card from the communication card in order to send unique data to the internet access system.

As described above, in an Internet access system, a data transmission method in the Internet access system, and a portable information device which can be used for such system, an appropriate transmission bandwidth can be reserved for the user, because the transmission capability of a portable information device can be determined from a unique data of the portable information device. Accordingly, the common carrier can build a proper charging system and can provide a low-price data transmission service.

### BRIEF DESCRIPTION OF THE DRAWINGS

The present invention will be understood more clearly after reference to the drawings shown below and to a preferable embodiment to carry out the invention.

FIG. 1 is a schematic diagram showing an Internet access system and a portable information device according to the present invention.

FIG. 2 is a schematic block diagram showing an internal structure of a portable information device.

FIG. 3 is a sequence diagram showing an example of data transmission process.

FIG. 4 shows an example of an authentication server.

### DESCRIPTION OF THE PREFERRED EMBODIMENT

An internet access system, a data transmission method in the internet access system and a portable information device which can be used for the system of the present invention will be described below with reference to attached drawings.

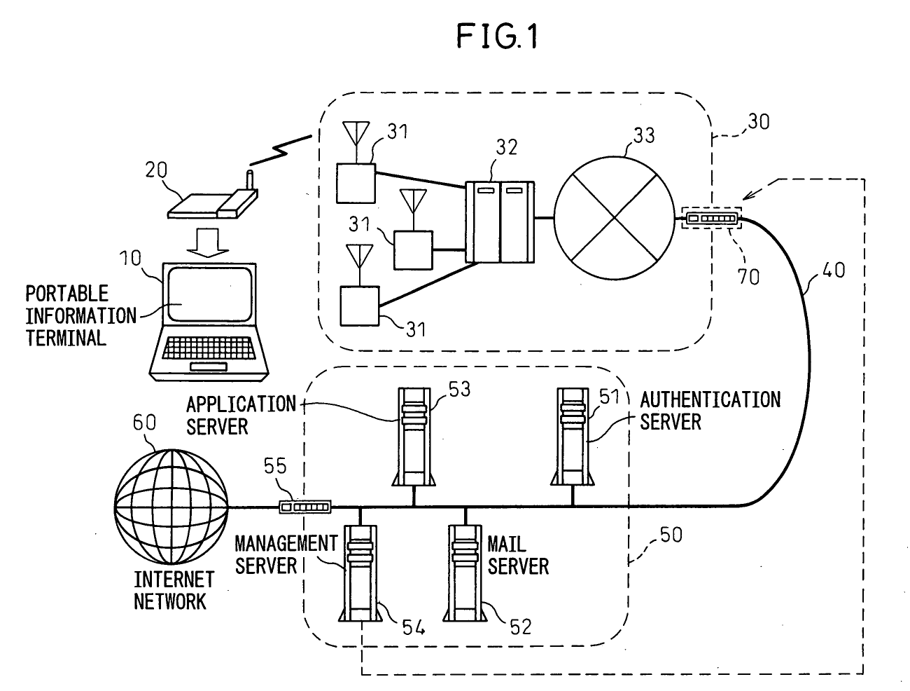

In FIG. 1, a communication card 20 is connected to a portable information device 10. The portable information device 10 accesses a secondary common carrier 50 structured as an Internet access system via the communication card 20 through a primary common carrier using a predetermined protocol. The secondary common carrier 50 carries out an identification based on a predetermined data received from the portable information device 10 to connect the portable information device 10 and the Internet network 60. Accordingly, the user of the portable information device 10 can access a predetermined point on the Internet network 60.

The portable information device 10 is a terminal of a PDA or a PC etc., and has a connection part to connect a PC card (PCMCIA card) slot, a compact flash (CF) card slot, SD (Secure Digital) card slot, or a communication card 20 for a USB connector.

The communication card 20 can transmit data using PHS and is structured to be inserted into the PC card slot, CF card slot, SD card slot, or a USB connector. The communication card 20 can have a data transmission capability except PHS, such as PDC, GSM, CDMA.

A PC card is a united standard of an expansion card for a personal computer formulated by PCMCIA and JEIDA jointly, and is used for a flash memory card, a hard disk, a SCSI card, a LAN card, a modem card, and the like. There are three types of PC card standard according to a thickness of the card, Type I, Type II and Type III. Type II is sold as a PHS communication for a notebook personal computer. The size of the PHS communication card for Type II is 54 mm×85.6 mm×5 mm (thickness). A CF card is a memory card standard advocated by SanDisk Corp. The size of the CF card is 36.4 mm×42.8 mm×3.3 mm (thickness), and is smaller than a PC card, therefore it is often used as a communication card for a mobile terminal. An SD card is a memory card standard advocated by SanDisk Corp., Matsushita Electric Industrial Co., Ltd and Toshiba Corp., jointly. The size of the SD card is 24 mm×32 mm×2.1 mm (thickness) which is smaller than the CF card.

The primary common carrier 30 is a mobile phone company such as NTT docomo Inc. and DDI pocket Inc. The primary common carrier 30 has a cellular network including a plurality of base station (BS) 31 and a gateway 32, and a circuit switching network including a cable network 33 or the like including plural exchanges. The circuit switching network includes a packet communication network to handle data of packet unit.

A secondary common carrier 50 is mobile virtual network operator (MVNO) who purchases a line at a wholesale price from the primary common carrier 30 and sells to a user a data service or an added value service, and connects the circuit switching network by the primary common carrier and the Internet network 60 bilaterally. Consequently, the secondary common carrier 50 is connected to the primary common carrier 30 by an exclusive line 40, and a user who accesses the secondary common carrier can use the Internet service as he/she is moving even through the secondary common carrier itself does not have a function to support the mobile.

A system of the secondary common carrier 50 is comprising a authentication server 51, a mail server 52, an application server 53, a management server 54 and the like, and is structured to enable to establish communication connection between the portable information device 10 and a WWW server or a mail server on the Internet network 60 via a router 55. The authentication server 51, as described below, performs certification of a transmission capability of the portable information device 10, and an identification of a user who uses the portable information device. The mail server 52 provides the user with an e-mail service. The management server 54 performs a charging management to the user and a client management and the like.

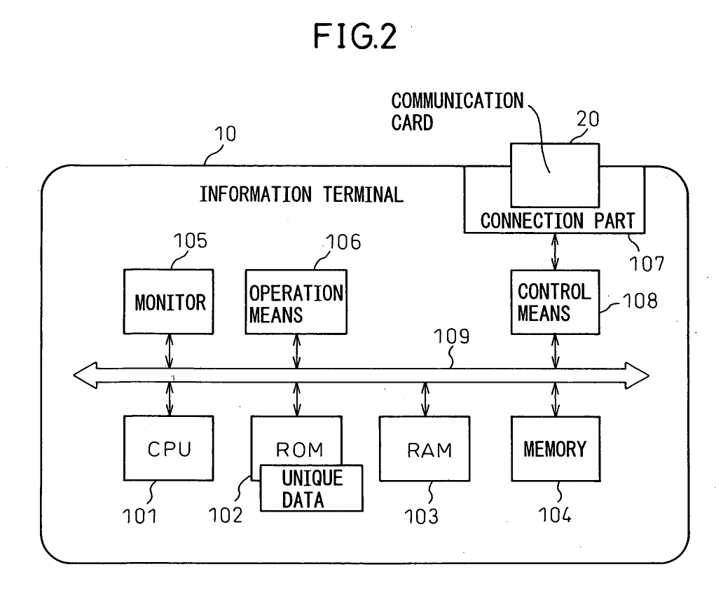

FIG. 2 is a schematic block diagram showing an example of an internal structure of a portable information device.

The portable information device 10 is, as shown in the drawing, comprised of a CPU 101, a ROM 102, a RAM 103, a memory 104 to store a transmission protocol, a user data and a different setting data, a monitor 105, an operating means 106, a connection part 107, a connection part control means 108, etc. Each means of the portable information device 10 is connected to enable to send and receive a data each other by a bus 109. In the ROM 102, a unique data to preliminarily authenticate the transmission capability of the portable information device 10 (for example, the average throughput 32 kbps or 8 kbps, etc,) is stored as not to be rewritten.

For the unique data, for example, an eight digit number is used. The front first to second digits represent a manufacturer of the portable information device, the third to sixth digits represent a serial number of the portable information device, the seventh and eighth digits represent a transmission capability (for example, 32, 64, or the like). However, another data which can represent the inherent transmission capability of the portable information device can be acceptable. Moreover, the ID data of the portable information device can be treated as a unique data showing the transmission capability of the portable information device. The average throughput of the portable information device 10 means the average amount of data which is sent and received by the portable information device for a predetermined time, and is roughly determined by the CPU 101, the memory 104 and a communication application such as a browser or a mailer used in the portable information device 10.

The connection part 107 is a PC card slot, CF card slot, SD card slot, or a USB connector, and is structured that the communication card 20 to be used can be connected.

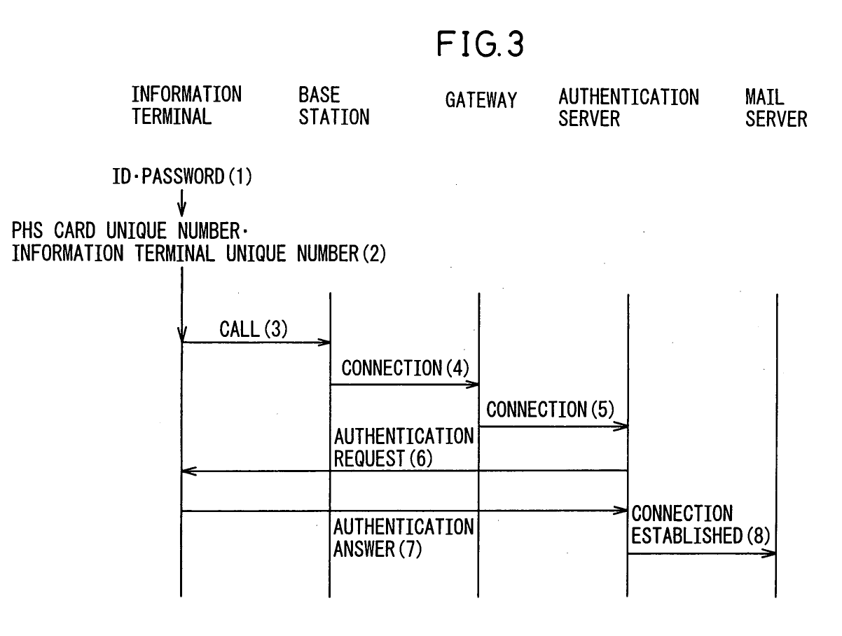

FIG. 3 is a sequence diagram showing an example of data transmission process of a data transmission system.

A case in which a user accesses a particular mail server using a secondary common carrier 50 will be explained below.

First, the user inputs a password given from the secondary common carrier using the operating means 108 to be stored in the memory 104 (Step 1). Namely, the ROM 102 corresponds to a first memory part to store a unique data of the portable information device, and the memory 104 corresponds to a second memory part to store a rewritable user ID and a password. The user ID and the password can be stored in the ROM 102 and RAM 103 of the portable information device 10.

Next, the portable information device 10 obtains a unique data of the communication card 20 and a unique data of the portable information device 10 which is preliminary stored in the ROM 102 (Step 2).

The portable information device 10 makes a call to a cellular network via the communication card 20 using a phone number specified by the secondary common carrier 50 to access a base station 31 of a cell in which the portable information device is located (Step 3). The phone number specified by the secondary common carrier 50 can be preliminarily stored in the communication card 102 or input or stored using the operating means 108 of the portable information device 10 by the user, or in the ROM 102 of the portable information device 10.

Next, the base station 31 accesses the gateway 32 (Step 4).

Next, the gateway 32 accesses the authentication server 51 of the secondary common carrier 50 via a cable network 33 and an exclusive communication cable 40 of the secondary common carrier 50 according to the called phone number (Step 5).

Next, the authentication server 51 requests an identification to the portable information device 10 (Step 6).

The identification-requested portable information device 10 sends the user ID, password, a unique data of the communication card and a unique data of the portable information device 10 to the authentication server 51 (Step 7).

The authentication server 51 determines a permission/no permission for accessing the Internet based on the received user ID, the password, the unique data of the communication card 20 and a unique data of the portable information device 10. If the authentication server 51 permits the access, the portable information device 10 accesses the mail server specified on the Internet network 60 (Step 8) and the communication between the user and the mail server can be established.

In the example shown in FIG. 3, the authentication server 51 uses a user ID, a password, a unique data of the communication card 20 and a unique data of the portable information device 10. However, the authentication server 51 can perform a user authentication using only the user ID and the password, or the user ID, the password or a unique data of the portable information device 10.

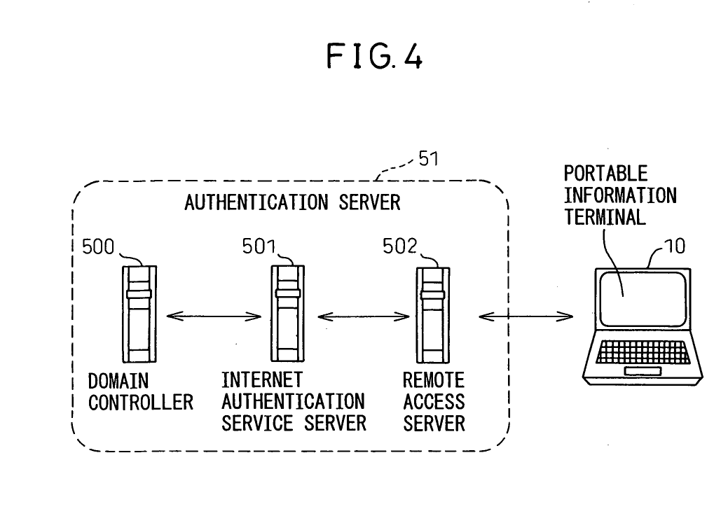

As shown in FIG. 4, a case in which the authentication server 51 includes a domain controller 500 which manages user authentication information, an Internet identification service server 501 as RADIUS (Remote Authentication Dial In User Service), and a remote access server 502 as a client of the RADIUS will be explained in detail below.

The communication between the remote access server 502 and the portable information device 10 is performed using PPP (Point to Point Protocol). The PPP is a protocol using a serial line in a Data Link Layer and supports a plurality of Network Layer protocols, and is useful when an IP connection is made in a public network. An authentication in the remote access server 502 is performed by PAP (Password Authentication Protocol) or CHAP (Challenge Handshake Authentication Protocol).

The remote access server itself does not have an identification data, and RADIUS authentication is carried out with the Internet authentication service server 501. The Internet authentication service server 501 performs user authentication between the domain controller 500 which manages user authentication data.

The RADIUS authentication is a protocol which provides an authentication/charging function to the remote access server 502. The most important function of the RADIUS authentication is permitting/rejecting an access according to a database recording the user information. In an actual RADIUS authentication, not only the user name and the password but also data called an attribute such as a connecting time, the amount of input/output data, a call back ID, a used port number, etc. can be corrected at the same time. Accordingly, an accounting function to correct statistics information of the connection can be added to the RADIUS authentication. Therefore, the remote access server 502 requests a user authentication and a charging service to the Internet authentication service server (RADIUS server) 501. The Internet authentication service server 501 replies an answer based on the management information structured on the server in response to the request. Using RADIUS authentication, identification information such as a user password in a plurality of remote access servers or charging information can be consolidated in a single Internet authentication service server 501.

In case of using PAP, the portable information device 10 sends a data in which the user ID and the unique data of the portable information device 10 are coupled and the password in response to the authentication request from the authentication server 51. For example, one bite can be add to the header to show the length of the unique data of the portable information device 10, so that the separation of the user ID and the unique data of the portable information device 10. If the user ID is “user 1” and the unique data of the portable information device 10 is “00112233”, the portable information device 10 send the password as encrypted to “800112233user1”.

In case of using CHAP, the portable information device 10 calculates a hash value by coupling a challenge number sent by the authentication server 51 and the password, and sends the hash value and a data in which the user ID and the unique data of the portable information server 10 is joined to the authentication server 51.

In both cases, the authentication server 51 initially separates the unique data of the portable information device 10 and the user ID from the received data, and then certifies whether or not the user can be accepted according to the user ID and the password. The determination whether or not the user ID and the password are appropriate is performed based on a separately structured database.

The unique data of the communication card 20 can be encoded likewise the unique data of the portable information device 10 and used for authentication between the remote access server 502 and the Internet authentication service server 501.

Next, the transmission speed is certified using a separately structured database to determine whether or not it is identical to the contents of the contract with the user, and it is determined whether or not the terminal can be accepted. For example, in case that the initial contents of the contract is to use a portable information device whose transmission speed is 32 kbps or less, if the authentication server 51 determines that the transmission capability of the presently used portable information device is 64 kbps at the maximum based on the unique data of the portable information device, the access from the portable information device 10 to the Internet network 60 cannot be authorized.

In the above example, the authentication server 51 processes do not to allow the access to the Internet network 60 if the received transmission capability of the portable information device exceeds the transmission capability in the contract. However, the authentication server 51 can cancel the unmetered flat-rate system and changes to another rating system based on the connection time in spite of rejecting the access.

Furthermore, plural different rate zone (connection rank) can be set in the unmetered flat-rate system. For example, when a user who subscribed in the rate zone of the lowest price uses data exceeding the transmission capability of the specified zone by a different portable information device, the authentication server 51 notifies the user to change the rate zone into one appropriate to the capability of the used portable information device, and the fee is charged according to the changed rate zone.

For example, the rating in unmetered system can be set as follows.
Zone A: 32 Kbps Unmetered+No limitation on terminal 4000 yen/Month
Zone B: 32 Kbps Unmetered+for terminal model A group 2000 yen/Month
Zone C: 32 Kbps Unmetered+for terminal model B group 1500 yen/Month
Zone D: 32 Kbps Unmetered+for terminal model C group 1000 yen/Month

In such a system, the user can continuously perform connection within an unmetered system of flat-rate, and can access the Internet without concerning to exceed the rate remarkably in metered system.

Moreover, the secondary common carrier 50 sums the transmission capability of portable information devices of all of the users in real-time in the management server 54, and can ask the primary common carrier to change the transmission capacity of the line which is purchased by the primary common carrier. For example, in case that the secondary common carrier 50 initially purchases lines of 8 Mbps, when the sum of the transmission capability of the portable information devices of all users accessing in a certain term is sufficiently smaller than 4 Mbps, the secondary common carrier 50 can ask the primary common carrier to change the capacity of the purchased lines to 4 Mbps from 8 Mbps. In such case, for example, it is preferable to provide a transmission capacity changing means 70 in the exclusive line 40 with the primary common carrier in order to change the transmission capacity to the most appropriate value by the management server 54.

In the above description, an example in which communication is carried out by attaching the communication card 20 to the portable information device 10. However, the present invention can be applied to a portable information device having a communication function like the communication card 20, therein.

1. An Internet access system to mutually connect a circuit switching network and the Internet network, comprising:
a communication connector for establishing a communication connection to a predetermined point on the Internet in response to an Internet connection request from an information terminal,
a receiver for receiving a unique data from the circuit switching network to authenticate the information terminal, and
a determination section for determining a transmission capability of the information terminal based on the unique data.

2. The Internet access system according to claim 1, wherein the communication connector establishes the communication connection between the information terminal and the predetermined point on the Internet network corresponding to the connection request, when the transmission capability satisfies predetermined criteria.

3. The Internet access system according to claim 1, wherein the transmission capability is an average throughput.

4. The Internet access system according to claim 1, wherein a communication card is connected to the information terminal, and the Internet access system receives the unique data, an user ID and a password of the information terminal via the communication card and the circuit switching network.

5. The Internet access system according to claim 4, wherein the information terminal is a portable information device.

6. The Internet access system according to claim 4, further comprising:
an authentication section for authenticating a user using the information terminal based on a user ID and a password, and
wherein the communication connector establishes the communication connection between the information terminal and the predetermined point on the Internet network corresponding to the connection request when the transmission capability satisfies predetermined criteria and the user authentication is certified.

7. The Internet access system according to claim 6, wherein the authentication section uses a data synthesized the user ID and the password for authentication.

8. The data transmission method in a Internet access system to mutually connects a circuit switching network and the Internet network, the method comprising the steps of:
receiving an unique data for authenticating an information terminal from a circuit switching network;
determining a transmission capability based on the unique data; and
establishing a communication connection between the information terminal and a predetermined point in the Internet network corresponding to a connection request from the information terminal.

9. The data transmission method according to claim 8, wherein the communication establishing step establishes the communication connection between the information terminal and the predetermined point in the Internet network when the transmission capability satisfies a predetermined criteria.

10. The data transmission method according to claim 8, wherein the determining step determines the transmission capability based on an average throughput of the information terminal.

11. The data transmission method according to claim 8, wherein a communication card is connected to the information terminal, and the Internet access system receives the unique data and a user ID and a password of the information terminal via the communication card and the circuit switching network.

12. The data transmission method according to claim 8, wherein the information terminal is a portable information device.

13. The data transmission method according to claim 11, further comprising the step of conducting an authentication of a user who uses the information terminal based on the user ID and the password, and
wherein the communication establishing step establishes the communication connection between the information terminal and the predetermined point in the Internet network when the transmission capability satisfies a predetermined criteria and the user authentication is certified.

14. The data transmission method according to claim 13, wherein the authentication step uses a data synthesized the user ID and the password for authentication.

15. A data transmission method in a Internet access system to mutually connects a circuit switching network and the Internet network in response to Internet connection request from a portable information device to which a communication card is connected, the method comprising the steps of:
receiving a unique data for authenticating an information terminal and a user ID and a password for using the portable information device from the circuit switching network;
determining an average throughput based on the unique data of the portable information device;
conducting an authentication of a user who use the portable information device based on the user ID and the password; and
establishing a communication connection between the portable information device and a predetermined point in the Internet network corresponding to an connection request from the information terminal at a predetermined connection rank when the transmission capability satisfies a predetermined criteria and the user authentication is certified.

16. The data transmission method according to claim 15, wherein the communication connection between the information terminal and the predetermined point in the Internet network corresponding to the connection request is refused when the average throughput does not satisfy a predetermined criteria or the user authentication is not certified.

17. The data transmission method according to claim 15, wherein the communication connection between the portable information device and the predetermined point in the Internet network corresponding to the connection request is established at a connection rank other than the predetermined connection rank according to the average throughput when the average throughput does not satisfies a predetermined criteria but the user authentication is certified.

18. An information terminal using an Internet access system to mutually connect a circuit switching network and an Internet network, comprising:
a connector for connecting a communication card;
a first memory for storing a unique data to authenticate a transmission capability of the information terminal;
a second memory for storing a user ID and a password to use the Internet access system; and
a processor for taking the unique data, the user ID and the password from the first and second memories, at an access to the Internet access system, so as to send the unique data, the user ID and the password to the Internet access system by using the communication card.

19. The information terminal according to claim 18, wherein the unique data represents at least a transmission capability of the information terminal.

20. The information terminal according to claim 18, wherein
the communication card has a unique data of the communication card, and
the processor takes the unique data of the communication card from the communication card in order to send the unique data of the communication card to the Internet access system.
